(19) United States
(12) Patent Application Publication
(10) Pub. No.: US 2008/0121143 A1
(43) Pub. Date: May 29, 2008

(54) Method of Manufacturing Building Materials and Use Thereof

(75) Inventors: Arne Villumsen, Kgs. Lyngby (DK); Bente Frydenlund, Kgs. Lyngby (DK)

Correspondence Address: DARBY & DARBY P.C., P.O. BOX 770, Church Street Station, New York, NY, 10008-0770, US

(73) Assignee: DANMARKS TEKNISKE UNIVERSITET, Kgs. Lyngby (DK)

(21) Appl. No.: 11/719,879

(22) PCT Filed: Nov. 10, 2005
(86) PCT No.: PCT/DK2005/000722

§ 371 Date: Dec. 28, 2007

(30) Foreign Application Priority Data
Nov. 23, 2004 (DK) PA200401820

(51) Int. Cl. C04B 14/10

(52) U.S. Cl. 106/720; 106/719

(57) ABSTRACT

The method according to the invention allows insulating clinker, beads, to be manufactured on the basis of materials which are present in arctic regions. These materials comprise clay and silt (1) and porosity agents (2) comprising granular shrimp and crab shells as well as oil in the form of waste oil or blubber. When lumps of this material (3) after drying (3) are fired (5), blistered clinker (6) is formed, which is suitable as an insulation material. Hereby, insulationtion materials may be produced in arctic regions on the basis of the occurring types of clay and using waste products, such as oil and shrimp/crab shells.

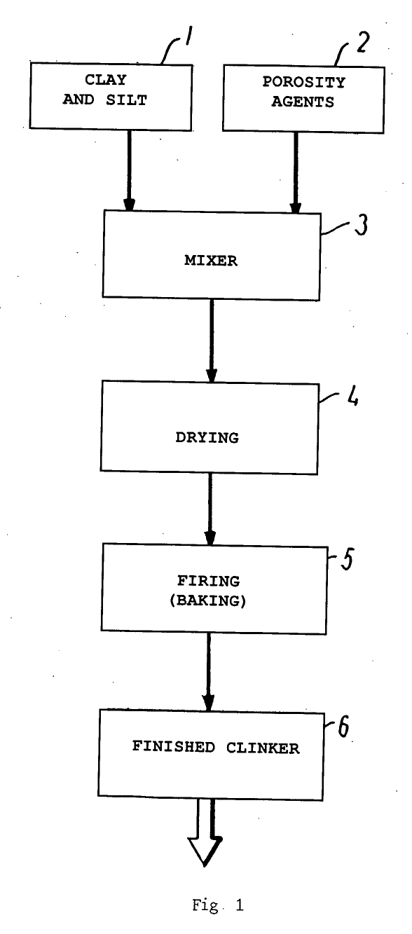

### THE STATE OF THE ART

The invention relates to a method of manufacturing building materials having a low specific weight, in particular in the form of small beads, clinker, with the following process steps:
making a material mix consisting of clay with admixture of additives in the form of porosity agents, drying, and firing,
as well as use thereof.

Building materials having a low specific weight are used in various forms to achieve a durable and heat-insulating material.

This may be in the form of beads or clinker which are used in a loose form or are optionally bonded by means of cement for the moulding of blocks or bricks.

Clay is used as a base material for making such materials, into which porosity agents are added and mixed, which when being burnt leave the caviTIES which are characteristic of this material.

Porosity agents are known in various forms in the form of burnable materials, such as sawdust, powdered coal, pieces of paper, sphagnum, bone meal, etc., cf. e.g. the descriptions of U.S. Pat. No. 4,438,055 and DE 100 65 095 A1.

Moreover, it is known from JP2001-43309A to add 3-5 weight percent pulverized oyster shells to the material to make it lighter.

Oyster shells consist almost exclusively of calcium carbonate with a small content of calcium phosphate and organic substances. The amount of the latter may contribute to porosity and may serve as a porosity agent, but since the amount is so inconsiderable, it has no practical importance. I

It is common to the known porosity agents that they occur in those regions where clay occurs, and where, therefore, the production of such building materials can take place naturally.

For such materials in remote regions to be used, these materials must be transported over long distances and perhaps also in specific periods of the year, as far as arctic regions are concerned. This adds to the costs of the materials to such a degree that the use will be highly limited. THE OBJECT OF THE INVENTION

The object of the invention is to remedy this drawback, and this is achieved according to the invention in that the porosity agent used is granular shrimp and/or crap shells, chitin, alone or in combination with one or more porosity agents known per se.

In this surprisingly simple manner, the presence of the raw materials, viz. mineralogical and rock clay, as well as shrimp and/or crab shells is united with a great need for insulating building materials, which conditions are present in arctic regions, such as Greenland, Alaska, etc.

When, as stated in claim 2, silt, which occurs in arctic regions, is used in the material mix, this naturally occurring material may be used in an advantageous manner.

When pulverized shrimp and crab shells are added, which are available, and which moreover constitutes a great waste problem for the processing industry of these fish, insulated building materials may be made in situ by the firing of the material.

This reduces the costs to a considerable degree, since the transport costs are reduced, and waste products are utilized, which would otherwise constitute a problem.

When, as stated in claim 3, oil, such as a waste oil or oil-containing waste, such as blubber, is added, a good blistering and thereby good insulating properties are achieved together with the porosity agents.

When, as stated in claim 4, agents, such as NaCO₃, are added, the melting point will be lowered, and perfect porous clinker is achieved.

When, as stated in claim 5, the crushed shells are added in an amount which does not exceed 10 weight percent, a pressure-proof clinker with a relatively low specific weight is achieved.

When, as stated in claim 6, other known porosity agents are added, building materials having specific properties to satisfy requirements of inter alia porosity, surface firmness, etc. may be manufactured.

Further, it is expedient, as stated in claim 7, to use the beads or the clinker as a loose insulation material, as this provides for a fill inexpensive in view of the circumstances, which satisfies all requirements made in respect of the properties of such a material, such as insulation capacity, stability, etc.

When, as stated in claims 8 and 9, the loose fill material is bonded together with cement, all forms of insulation materials may be manufactured, such as bricks, blocks, elements, floors, etc.

### THE DRAWING

An example of an embodiment of the method of manufacturing loose light clinker will be described more fully below with reference to the diagram, which schematically illustrates the method steps.

### DESCRIPTION OF AN EXEMPLARY EMBODIMENT

An exemplary embodiment of the method according to the invention will be described first with reference to the diagram.

The raw materials for use in the method is clay 1 in the form in which it occurs in the arctic regions, and which contains silt, the so-called Greenland clay. It is a natural deposit from clay components which are suspended in river water. When this water meets sea water, the components are precipitated. Clay and silt are therefore freely accessible in nature and can readily be included in the production of the building material according to the invention.

The porosity agent 2 is pulverized shrimp and/or crab shells, which shells are a waste product from the industries, such as freezing and canned food industries, which are located in these regions where fishing of these fish takes place.

Maximum 10 weight percent of this porosity agent is added to the clay and the silt. These components 1, 2 are mixed in a generally known mixer 3.

Oil, either in the form of waste oil or biological waste, such as blubber, is added to the mixture.

This oil addition gives a high and homogeneous blistering of the porosity agents, which results in good insulating properties.

To this should be added that a great waste problem in the arctic regions, in particular as regards waste oil, is remedied hereby in an expedient manner.

In those cases where additional porosity is required, generally known porosity agents may be added in an amount of up to 25 weight percent, plus the up to 10 weight percent crushed shells.

Agents which lower the melting point, such as NaCO₃ or the like, may be added, which ensures a perfect firing and end product.

The components 1, 2 are mixed in a generally known mixer 3, following which the mixture is dried in a drying chamber 4.

Small lumps of the material are then supplied in an even flow in a tunnel kiln 5, where these lumps are fired to clinker, and when the porosity agents are burnt, blisters are generated to thereby produce porous light clinker 6.

This loose insulation material has all the properties which are to be provided, viz. low cost, insulation capacity, low weight, and this without the material containing harmful chemical components.

The material 6 may be used in a loose form for filling cavities and the like, or it may be mixed with cement and water and then be moulded in a mould into blocks, bricks and similar components.

1. A method of manufacturing building materials with a low specific weight, in the form of small beads, clinker, which comprises steps:
making a material mix consisting of clay with an
admixture of additives in the form of porosity agents, drying,
and firing the material mix,
wherein in that the porosity agent comprises granular shrimp and/or crab shells, chitin, alone or in combination with one or more known porosity agents.

2. A method according to claim 1, wherein the material mix contains silt.

3. A method according to claims, wherein waste oil or oil-containing biological waste, is additionally admixed with the material mix.

4. A method according to claims 1, which comprises adding melting point lowering agents, to the material mix.

5. A method according to claim 1, wherein granular shells,and/or chitin, comprises up to 10 weight percent of the material mix.

6. A method according to claims 1, which comprises adding up to 30 weight percent of porosit agents to the material mix and said material mix comprising up to 10 weight percent granular shells.

7. Use of the building material manufactured A loose insulation material made by the method of claims 1 in the form of fired beads or clinker.

8. Loose insulation material according to claim 7, wherein the loose material is bonded with cement to form building materials in block or brick form.

9. Use A mold comprising the loose insulation material according to claim 8.
